(19) United States
(12) Patent Application Publication
(10) Pub. No.: US 2003/0168530 A1
(43) Pub. Date: Sep. 11, 2003

(54) Fuel injection valve

(76) Inventors: Ferdinand Reiter, Markgroeningen (DE); Ottmar Martin, Pettstadt (DE)

Correspondence Address: KENYON & KENYON, ONE BROADWAY, NEW YORK, NY, 10004, US

(21) Appl. No.: 10/240,462

(22) PCT Filed: Jan. 28, 2002
(86) PCT No.: PCT/DE02/00296

(30) Foreign Application Priority Data
Jan. 30, 2001 (DE) 101 03 932.8

(51) Int. Cl. F02M 51/00; B05B 1/30

(52) U.S. Cl. 239/585.1

(57) ABSTRACT

A fuel injector (1), in particular for direct injection of fuel into a combustion chamber of a mixture-compressing, spark-ignited internal combustion engine, has a nozzle body (2) that forms a housing body with an external pole (9) and a coil housing (11), a magnet coil (10) that is electrically energizable by way of a lead (19) and a plug contact (17), and a central fuel supply (16). The lead (19) and the fuel supply (16) are together positioned in an adapter (18) that can be placed onto an inflow end (34) of the housing body and is joinable thereto.

### BACKGROUND OF THE INVENTION

The present invention starts out from a fuel injector according to the species defined in the main claim.

In known electromagnetically actuable fuel injectors, a valve tube that constitutes the basic element of the fuel injector is made up of three parts. A core and a valve seat support are joined to one another in hydraulically sealed fashion via a nonmagnetic spacer, at least two fitting and joining points being necessary.

German Patent 195 03 821 A1 discloses a fuel injector in which the number of components of the valve tube is decreased, so that the number of joining and fitting points is also reduced. The entire valve tube is fabricated from magnetically conductive material, so that magnetically nonconductive spacers can be dispensed with.

A disadvantage of the fuel injector known from German Patent 195 03 821 A1 is that the housing shape of this fuel injector is not suitable for some applications in the context of direct fuel injection, since it is too short in terms of the existing installation situation and is not sufficiently sealed with respect to the engine compartment.

### ADVANTAGES OF THE PRESENT INVENTION

The fuel injector according to the present invention having the characterizing features of the main claim has, in contrast, the advantage that the individual lines that ensure the supply of electricity and of fuel are guided, in an adapter that lengthens the fuel injector, in such a way that the unit as an overall component is sealed against the pressure in the intake manifold and/or in the combustion chamber. Installation is thereby also facilitated, since the supply lines are more easily accessible and are all positioned at one point.

Advantageous developments of and improvements to the fuel: injector described in the main claim are made possible by the features set forth in the dependent claims.

It is also advantageous that the adapter is constructed from two easily manufactured tubular hollow bodies that can be inserted into one another.

It is furthermore advantageous that the adapter can be positively attached onto the fuel injector before welding, which simplifies final assembly.

Advantageously, the fuel supply is provided in the one hollow body and the electrical lead in the other hollow body, so that the electrical lead can be routed easily and in a manner protected against damage.

Also advantageous is the fact that any desired fuel injectors can be equipped with the adapter according to the present invention.

### DRAWING

An exemplary embodiment of the invention is depicted in simplified fashion in the drawings and is explained in more detail in the description below. In the drawings:

FIG. 1 is a schematic section through an exemplified embodiment of a fuel injector configured according to the present invention; and

FIG. 2 is a schematic partial section through the fuel injector according to the present invention.

### DESCRIPTION OF THE EXEMPLARY EMBODIMENT

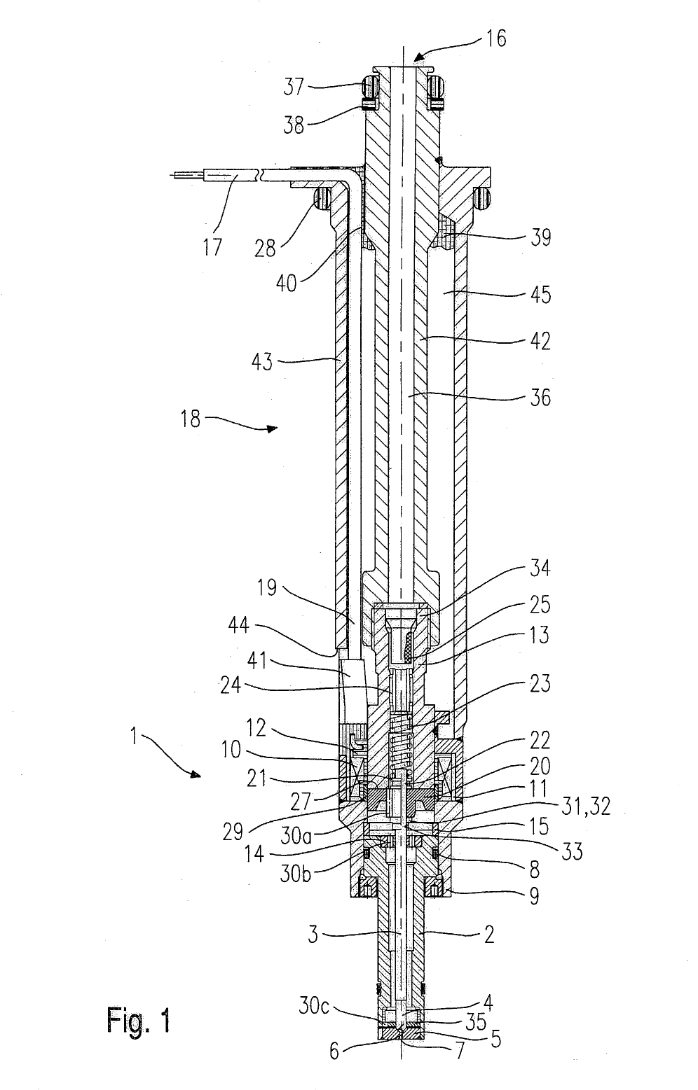

FIG. 1 shows, in a partial and schematic sectioned depiction,; a longitudinal section through an exemplified embodiment of a fuel injector 1 configured according to the present invention.

Fuel injector 1 is embodied in the form of a fuel injector for fuel injection systems of mixture-compressing, spark-ignited internal combustion engines. Fuel injector 1 is suitable in particular for direct injection of fuel into a combustion chamber (not depicted) of an internal combustion engine.

Fuel injector 1 has a nozzle body 2 in which a valve needle 3 is positioned. Valve needle 3 is in working engagement with a valve-closure member 4 which coacts with a valve-seat surface 6, positioned on a valve-seat member 5, to form a sealing seat. In the preferred exemplified embodiment, fuel injector 1 is an inward-opening fuel injector 1 that possesses at least one spray discharge opening 7. Nozzle body 2 is sealed by a seal 8 with respect to external pole 9 of a magnetic circuit. A magnet coil 10 is encapsulated in a coil housing 11 and wound onto a coil support 12 that rests against an internal pole 13 of the magnetic circuit. Internal pole 13 and external pole 9 are separated from one another by a gap 26, and are supported on a connecting component 29. Magnet coil 10 is energized, via a lead 19, by an electrical current that can be conveyed via an electrical plug contact 17. According to the present invention, lead 19 is positioned in an adapter 18 that is inserted via an inflow end 34 of fuel injector 1 and is preferably welded to fuel injector 1 in the region of magnet coil 10. Lead 19 is connected in electrically conductive fashion, preferably via a plug connector 41, to magnet coil 10.

Fuel is delivered via a central fuel supply 16 that is configured in an opening 36 of adapter 18 guided parallel to lead 19, and is filtered through a filter element 25 in inflow end 34 of fuel injector 1. Fuel injector 1 is sealed by way of a first seal 28 with respect to a cylinder head that is not depicted further, and by way of a second seal 37 with respect to a fuel line that is also not depicted further.

Adapter 18 is made up of two tubular hollow bodies 42 and 43 guided within one another: inner hollow body 42 conveys fuel out of the fuel line (not depicted) from central fuel supply 16 to filter element 25, while outer hollow body 43 receives lead 19 and inner hollow body 42.

Valve needle 3 is guided in a valve needle guide 14 that is of disk-shaped configuration. An adjusting disk 15 paired thereto serves to adjust the linear stroke. Located on the other side of adjusting disk 15 is an armature 20. The latter is joined nonpositively, via a first flange 21, to valve needle 3, which is joined to first flange 21 by way of a weld seam 22. Braced against first flange 21 is a return spring 23 which, in the present configuration of fuel injector 1, is preloaded by a sleeve 24.

A second flange 31, which is joined to valve needle 3 via a weld seam 33, serves as the lower armature stop. A flexible spacer ring 32, which rests on second flange 31, prevents bouncing when fuel injector 1 closes.

Configured on the inflow side of the sealing seat is a guidance disk 35 that ensures centered alignment of valve needle 3 and thus counteracts any tilting of valve needle and subsequent inaccuracies in the metered fuel quantity. Fuel conduits 30a through 30c extend in valve needle guide 14, in armature 20, and in guidance disk 35.

When fuel injector 1 is in the idle state, armature 20 is impinged upon opposite to its linear stroke direction by return spring 23 so that valve-closure member 4 is held in sealing contact on valve seat 6. Upon energization of magnet coil 10, the latter establishes a magnetic field that moves armature:20 in the linear stroke direction against the spring force of-return spring 23, the linear stroke being defined by a working gap 27 that is present, in the idle position, between internal pole 13 and armature 20. Armature 20 also entrains flange 21, which is welded to valve needle 3, in the linear stroke direction. Valve-closure member 4, which is in working engagement with valve needle 3, lifts off from valve-seat surface 6, and fuel is discharged.

When the coil current is shut off and once the magnetic field has decayed sufficiently, armature 20 falls away from internal pole 13 as a result of the pressure of return spring 23, thereby moving flange 21, which is in working engagement with valve needle 3, against the linear stroke direction. Valve needle 3 is thereby moved in the same direction, so that valve-closure member 4 is placed onto valve-seat surface 6 and fuel injector 1 is closed.

Sealing of adapter 18 against the pressure of the combustion chamber and the intake manifold is accomplished, during the assembly of fuel injector 1, in three different ways. Firstly the housing of fuel injector 1, constituted by nozzle body 2 and by external pole 9 of magnet coil 10, is fitted together and sealed against the external pressure by means of seal 8 positioned therebetween. The join between coil housing 11 and external pole 9 is preferably accomplished by welding, as is the join between coil housing 11 and adapter 18. Alternatively, coil housing 11 can also be configured integrally with adapter 18, so that one less fitting point occurs. Sealing against the pressure in the intake manifold and/or in the combustion chamber, as already mentioned above, is accomplished via first seal 28, whereas second seal 37 in combination with a backing washer 38 seals against the pressure in the fuel line.

Seals 8, 28, and 37 are preferably embodied as O-rings, which can be produced economically and in a manner resistant to influences such as heat or the dissolving characteristics of fuel. A recess 45 formed between inner hollow body 42 and outer hollow body 43, as well as other gaps 40 that occur, are filled with a sealing compound 39 and thus also sealed.

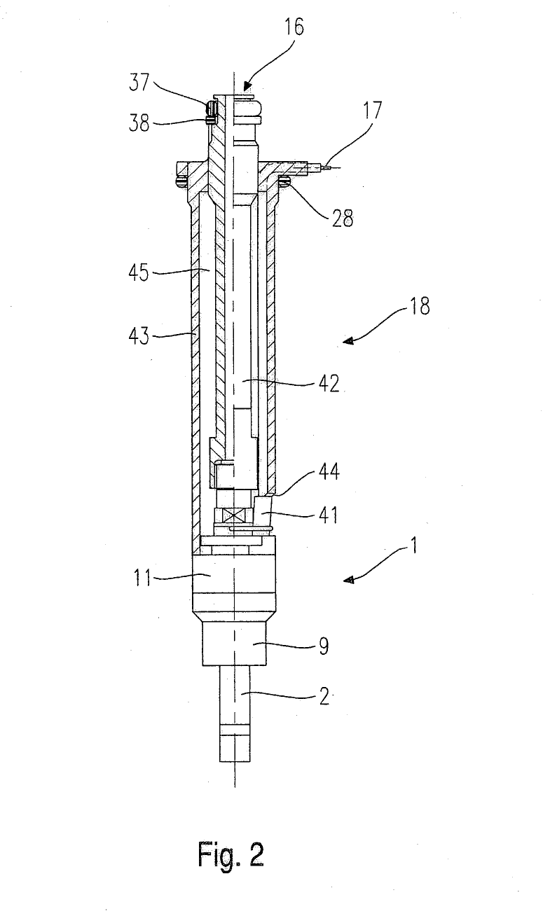

FIG. 2 shows fuel injector 1 configured according to the present invention, in a further schematic view that is only partially sectioned.

In order to illustrate the features according to the present invention, the outflow-end portion of fuel injector 1 is shown unsectioned. The housing parts that are joined to one another—nozzle body 2, external pole 9, and coil housing 11—are evident. Positioned at the inflow end of coil housing 11 is adapter 18, which is shown partially sectioned. The right side of the drawing shows inner hollow body 42 unsectioned, to illustrate that it can be easily slipped onto inflow end 34 of fuel injector 1. Outer hollow body 43, which is depicted in section, terminates flush with coil housing 11, a shoulder 44 being provided on the side of plug connection 41 in order to keep plug connection 41 externally accessible. Recess 45 between inner hollow body 42 and outer hollow body 43, and gaps 40 proceeding therefrom, are filled with sealing compound 39, so that easily implemented sealing can be accomplished especially in the critical region of the fuel supply conduit and the electrical contacts.

The invention is not limited to the exemplified embodiment depicted and is also applicable, for example, to fuel injectors 1 having magnetostrictive or piezoelectric actuators 10; and to fuel injectors 1 of any configuration.

What is claimed is:

1. A fuel injector (1), in particular for direct injection of fuel into a combustion chamber of a mixture-compressing, spark-ignited internal combustion engine, comprising a nozzle body (2) that forms a housing body with an external pole (9), comprising an actuator (10) that is electrically energizable by way of a lead (19) and a plug contact (17), and a central fuel supply (16),
wherein the lead (19) and the fuel supply (16) are together positioned in an adapter (18) that can be slipped onto an inflow end (34) of the housing body and is joinable thereto.

2. The fuel injector as recited in claim 1,
wherein the adapter (18) is assembled from two tubular hollow bodies (42, 43).

3. The fuel injector as recited in claim 2,
wherein the inner hollow body (42) is positioned in a recess (45) of the outer hollow body (43).

4. The fuel injector as recited in claim 2 or 3,
wherein fuel is conveyed through a opening (36) in the internal hollow body (42).

5. The fuel injector as recited in one of claims 2 through 4,
wherein the lead (19) is positioned in the recess (45) formed between the inner hollow body (42) and the outer hollow body (43).

6. The fuel injector as recited in one of claims 1 through 5,
wherein the adapter (18) is welded to the housing body constituted by the nozzle body (2), the external pole (9), and a coil housing (11) of a magnet coil (10).

7. The fuel injector as recited in one of claims 2 through 6 ,
wherein the recess (45) is filled with a sealing compound (39) for sealing.

8. The fuel injector as recited in one of claims 1 through 7,
wherein the adapter (18) is sealed by means of a first seal (28).

9. The fuel injector as recited in one of claims 1 through 8,
wherein the adapter (18) is sealed from a fuel line by a second seal (37).

10. The fuel injector as recited in claim 8 or 9,
wherein the first seal (28) and the second seal (37) are embodied as O-rings.
